(19) United States
(12) Patent Application Publication
(10) Pub. No.: US 2003/0144029 A1
(43) Pub. Date: Jul. 31, 2003

(54) Apparatus for wireless connectivity using software modem

(75) Inventors: Jon C.S. Wu, Taipei (TW); Ming-Hung Lin, Taipei (TW); Tom Chiu, Sunnyvale, CA (US)

Correspondence Address: Corporate Patent Counsel;, Philips Electronics North America Corporation, 580 White Plains Road, Tarrytown, NY, 10591, US

(73) Assignee: KONINKLIJKE PHILIPS ELECTRONICS N.V.

(21) Appl. No.: 10/122,258

(22) Filed: Apr. 12, 2002

Related U.S. Application Data
(60) Provisional application No. 60/352,121, filed on Jan. 25, 2002.

(51) Int. Cl. H04B 1/38

(52) U.S. Cl. 455/557; 455/41; 709/320

(57) ABSTRACT

The invention relates typically, but not exclusively, to wireless communication technology. More specifically, but not exclusively, it relates to a computing system and method using a computer host and wireless connectivity such as based on Wireless LAN or Bluetooth.

The invention also relates to a new architecture using a software modem for implementing a wireless communication system having a host and a transceiver device. The wireless communication system is based on a new functional partitioning. A part of the original functionality of the transceiver device is moved to a software program running on the host. As a consequence, the hardware cost of the transceiver device is reduced and the system flexibility is increased since it now, at least partly, based on a software solution.

### RELATED APPLICATION

This application claims priority to U.S. provisional application, serial No. 60/352,121 (attorney docket US028006P), by Jon C. S. Wu, Ming-Hung Lin and Tom Chiu, for “Apparatus for Wireless Connectivity Using Software Modem.”

### FIELD OF THE INVENTION

The invention relates typically, but not exclusively, to wireless communication technology. More specifically, but not exclusively, it relates to a computing system and method using a computer host and wireless connectivity such as based on Wireless LAN or Bluetooth.

The invention also relates to a new architecture using a software modem for implementing a wireless communication system having a host and a transceiver device. The wireless communication system is based on a new functional partitioning. A part of the original functionality of the transceiver device is moved to a software program running on the host. As a consequence, the hardware cost of the transceiver device is reduced and the system flexibility is increased since it now, at least partly, is based on a software solution.

### BACKGROUND ART AND SUMMARY OF THE INVENTION

Wireless communications technology has evolved rapidly along a logical path, from first-generation analog equipment for military or business use to today's digital, low-power mobile phone and wireless Internet connectivity. For computer applications, there has also been an increasing demand for replacing existing cables with wireless transceivers. By combining wireless technology with the Internet new business opportunities in the era of personal communications, convenient and creative value-added services can now be offered. Successful examples are i-Mode services offered by NTT DoCoMo and a dramatic growth of the PDA (Personal Digital Assistant) market in the past few years. It has been predicted that more and more people will be exchanging visual pages such as web contents for the purposes of business, entertaining, and living in the near future. Therefore, wireless connectivity for exchanging information is becoming a mandatory function on most of the computing hosts, e.g., on a laptop, a PDA, and a pocket PC.

A conventional approach for adding such wireless connectivity functions to a computing host is to have an add-on card as a separate peripheral device for part of the communication functions, e.g., a wireless LAN card (such as for 802.11a or 802.11b), a Bluetooth card. Thus, in the conventional approach there is a functional partitioning between the host and the add-on card. A typical solution following the standard OSI 7-layers uses the interface between layer 2 and layer 3 as the partitioning, as shown in FIG. 1. On the add-on card, it is typically a dedicated piece of hardware for achieving the specific functionality, for example, the data link layer and the physical layer.

Important criteria for the consumer's acceptance of a computing host for wireless personal applications are, amongst others, the physical size and form factor of the computing host (plus the add-on card). Moreover it should be very small and it should be easy to carry. This creates a need to reduce the size of the host and the add-on card. However, the computing host is responsible for executing the application program and should therefore be powerful enough. As a result, reducing the size of the add-on card becomes a possible attractive solution.

Another consideration is cost. Since wireless functionality is becoming a mandatory part, it is not cost effective to use an add-on card for this functionality. This is similar to the evolution of personal computers (PCs), where more and more, default, functionality was moved in the past to the PC's motherboard, e.g., serial port, parallel port, hard drive interface, LAN, modem, and so on. Therefore, it seems to be beneficial to an end user when he/she needs this functionality to have it included by default at the point of purchase. This seems to be similar for wireless functionality. However, moving more functionality to the motherboard may create problems such as a higher integration complexity, more complicated software for hardware management, etc.

It is an object of the present invention to provide an optimal solution to the above problems and issues. The invention proposes a system, method and software based on (?) a software module that provides wireless communication functionality (instead of a traditionally used hardware module). Instead of transforming a wireless add-on card to a hardware element on a PC's motherboard, the present invention moves part of the add-on card functionality to a software program or software module running on the CPU of the host. This is enabled by, e.g., a CPU for laptop, that these days can operate at a clock speed of 2 GHz or above and the CPU for pocket PC that these days can run a clock speed of 200 MHz or above. This avoids a potential hardware integration problem and the size of, e.g., an add-on card can be reduced. A partitioning that is proposed comprises a physical layer that is divided into two parts, an upper physical layer and a lower physical layer.

Additional advantages and novel features will be set forth in the description which follows, and in part may become apparent to those skilled in the art upon examination of the following, or may be learned by practice of the invention.

### BRIEF DESCRIPTION OF THE DRAWINGS

The invention is explained in further details, by way of examples, and with reference to the accompanying drawing wherein:

FIG. 1 is a typical wireless add-on card functionality;

FIG. 2 is a proposed functional partitioning;

FIG. 3 is a proposed wireless system using software modem;

FIG. 4 is a Bluetooth software modem and radio add-on module;

FIG. 5 is a UART emulation for virtual HCI layer.

FIG. 6 is a proposed device driver architecture for Bluetooth software modem with interface to HCI-UART without modifying HCI layer;

FIG. 7 A possible Bluetooth software modem implementation; and

FIG. 8 is an example of DH1 packet transmission using software modem.

### DETAILED EMBODIMENTS

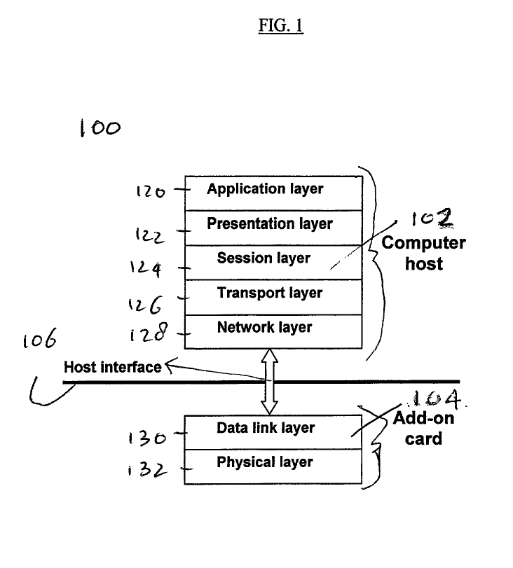

FIG. 1 shows a conventional and typical wireless add-on card functionality mapped on a seven-layer OSI model 100. OSI model 100 comprises an application layer 120, a presentation layer 122, a session layer 124, a transport layer 126, a network layer 128, a data link layer 130 and a physical layer 132. A computer host 102 implements the upper five layers and an add-on card 104 the lower two layers. The computer host 102 and the add-on-card 104 are connected to each other by means of host interface 102 that is located between the network layer 128 and the data link layer 130.

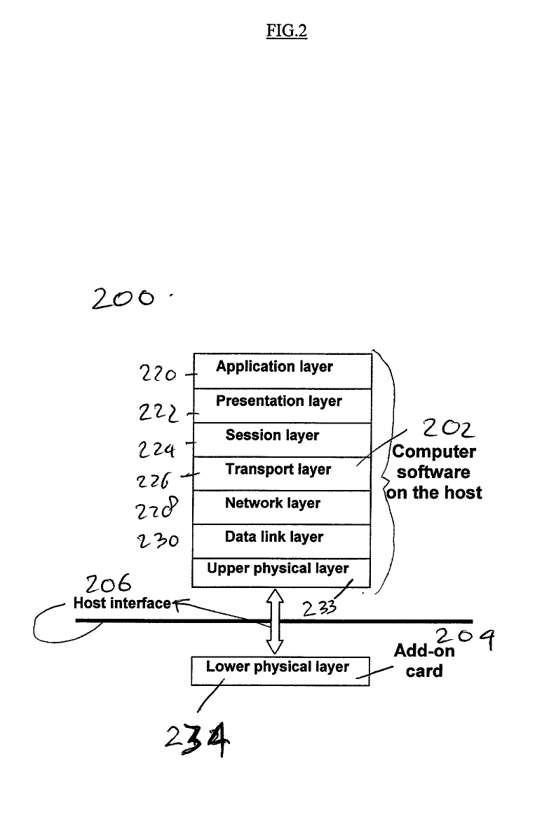

The general concept of a proposed partitioning of the invention, mapped on a seven-layer OSI model 200, is presented in FIG. 2. The present invention is based on a new functional partitioning for integrating wireless connectivity functions to a computing host. OSI model 200 comprises an application layer 220, a presentation layer 222, a session layer 224, a transport layer 226, a network layer 228, a data link layer 230, an upper physical layer 233 and a lower physical layer 234. Computer software on the host 202 implements the upper six layers and part of the upper physical layer 233. An add-on card 204 implements the lower physical layer 234. The computer host 202 and the add-on-card 204 are connected to each other by means of host interface 202 that is located between the upper physical layer 233 and the lower physical layer 234.

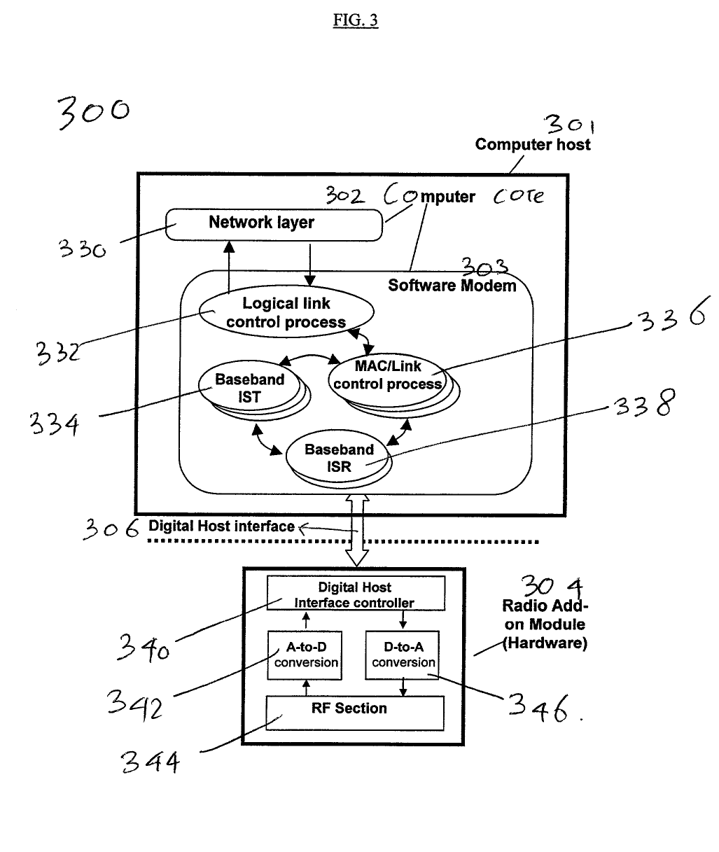

A more detailed and specific example of a system architecture for a wireless system using a software modem is shown in FIG. 3. Personal computer 300 comprises a computer host 301 and a radio add-on module 304 that are connected to each other through digital host interface 306. Computer core 302 comprises software modem 303 and network layer 302. The wireless system comprises two major components, a software modem 303 and the radio add-on module 304, explained below. The radio add-on module 304 is a relative simple and low-cost piece of hardware for performing the following functions:

Receiving radio signals from RF in RF section 344 and converting them into digital signals in ADC converter 342, and send these signals to the host;

Accepting digital signals from the host over digital host interface controller 340 and converting them into analogue ones using DAC converter 346, and send them out to the RF by RF section 344; and

Accepting digital control signal from the host over digital host interface controller 340 for performing control functions on the RF section 344, for example, power control, frequency tuning.

On the computer host 301, all of the required baseband functions and above are executed in software. Computer host 301 comprises software modem 303 and network layer 330 that can communicate with each other in a bi-directional fashion. Software modem 303 can communicate with the radio add-on module 304 using digital host interface 306. The software modem 303 exists as a software device driver for communicating with the said radio add-on module 304 to perform necessary functions such as:

Baseband algorithms like forward error correction (FEC), cyclic redundant checksum (CRC), encryption, channel coding, authentication, and synchronization.

Data link layer or MAC layer functions such as multiple access control, ARQ, paging, inquiry, . . .

Link management functions like connection establishment, bridging, routing, . . .

Interfacing with (upper) network layer 302

In FIG. 3, the software modem comprises a plurality of software processes called Baseband ISR (Interrupt Service Routine) 338, Baseband IST (Interrupt Service Thread) 334, and general processes. The ISR 338 contains those procedures that directly interact with the hardware signals, e.g., coming from radio add-on module 304 and thus should have real-time performance. The IST also deals with hardware signals but with a secondary priority. For those common procedures on the higher layers, software processes are used. Therefore, in FIG. 3, there are typically a plurality of Baseband ISR 338, a plurality of Baseband IST 334, and a plurality of MAC/Link control process 336, and a logical link control process 332 that interfaces the software modem 303 to the (upper) network layer 330.

In a conventional design ISR 338 and IST 334 are achieved by hardware, e.g., by using a hardwired silicon chip or a programmable logic array on a silicon chip. Even when modem functionality became (and still is becoming) integrated on the host computer the functional partitioning remained the same, e.g., in OSI model terms. The invention however takes advantage from host processor power and performs certain, thus far in hardware implemented, functions in software running on the host processor. The implementation of these functions, and in particular the IST 334, ISR 338 and part of interface 306, in software is far from trivial. From a pure component point of view it will be cheaper to offer a hardware-based solution since the host processing power requirements may drive up the host computer cost. The inventors however found it advantageous to implement certain functions (the preferred embodiment includes at least: ISR 338, IST 334, part of interface 306 and possibly other functions) in software. These advantages include, but are not limited to:

high flexibility for switching from one type of ISR/IST to another is easy with little additional hardware cost (e.g., when a user wants to use a Bluetooth based service at one moment and an 802.11b based service the next moment this is possible by replacement to a relative simple 802.11b RF-front-end part plus a host based software module);

a quick time to market opportunity (among others due to reuse, usage of proven software concepts);

higher reliability (less hardware components and therefore a smaller chance of hardware related problems);

in the field bug fixing is enabled; and

a software solution will, certainly in the mid/long term, result in a lower cost solution, especially taking serviceability, upgradability and maintenance into account.

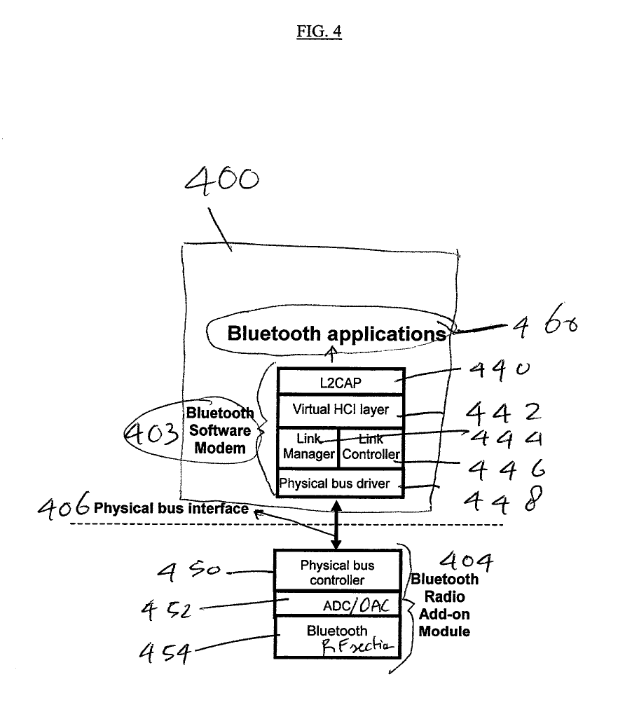

FIG. 4 is a graphical illustration of an embodiment of the invention using Bluetooth as an example. This embodiment illustrates a novel functional partitioning of a Bluetooth protocol stack 400 and thereby effectively reducing the system cost and physical size. Bluetooth protocol stack 400 and Bluetooth radio add-on module 404 are connected by means of a physical bus interface 406. The protocol stack comprises Bluetooth applications module 460 and Bluetooth software modem module 403. Bluetooth software modem module 403 comprises a L2CAP module 440, a virtual HCI layer module 442, a link manager module 444, a link controller module 446 and a physical bus driver module 448. Bluetooth radio add-on module comprises a physical bus controller 450, an ADC/DAC 452 and a Bluetooth RF-section 454.

The virtual HCI layer 442 refers to an extension of a conventional Bluetooth system. According to the Bluetooth specification, the HCI layer provides a transparent communication between the host and the Bluetooth device. Several HCI transport standards like UART, USB and PCMCIA have been defined. However, the host and the embedded Bluetooth device exchange standard HCI packets which are encapsulated by the lower HCI transport sub-layers, e.g., HCI-UART, and HCI-USB, and therefore will not be bothered by different physical buses. Since the present invention has proposed to push the link controller up to the host, the original HCI layer was pushed further inside. No more physical HCI transport buses are required. Thus, a virtual HCI layer is invented to retain the portability and integrality of the software.

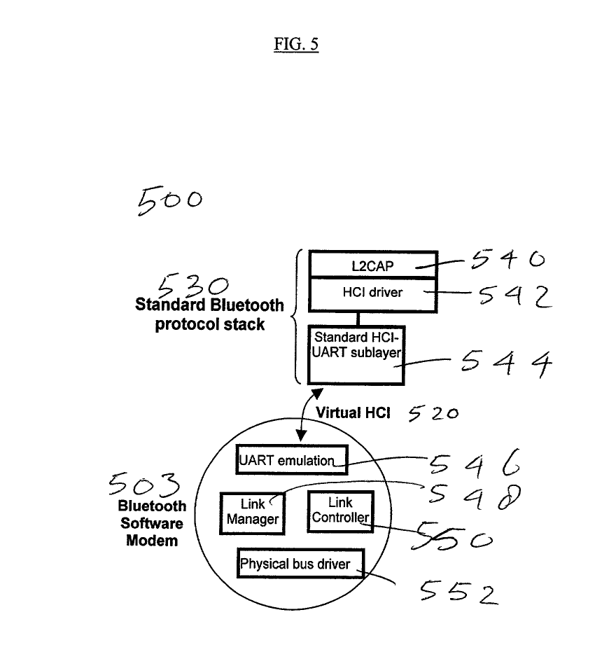

FIG. 5 is an illustration of a Bluetooth system 500 of the invention with a virtual HCI layer 520 using a standard HCI-UART sublayer module 544. Bluetooth system 500 comprises a standard Bluetooth protocol stack 530 and a Bluetooth software modem 503 that communicate with each other using the virtual HCI layer 520. The standard Bluetooth protocol stack comprises L2CAP module 540, HCI-driver module 542 and standard HCI-UART sublayer module 544. Bluetooth software modem 503 comprises a UART emulation module 546, a link manager module 548, a link controller module 550 and a physical bus driver module 552. Since most of the Bluetooth software protocol stack 530 supports a UART interface as the HCI transport layer, it is adequately to simulate the UART interface, visualized by the standard HCI-UART sublayer 544, on top of the Bluetooth software modem 503.

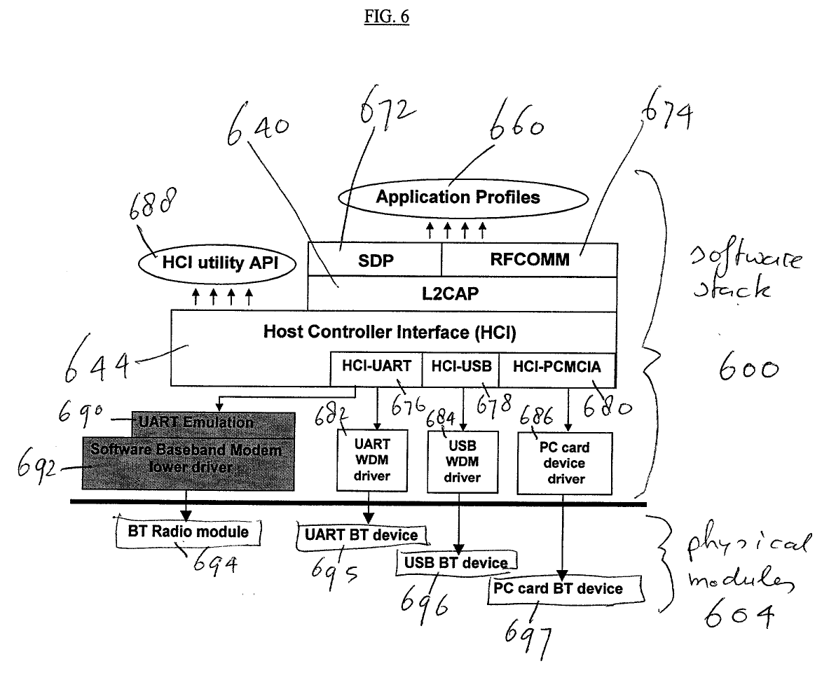

As a consequence of using the UART emulation 546, the Bluetooth software modem 503 can be seen as a standard UART device, which is attached to the computer host. This guarantees the interoperability of the proposed Bluetooth software modem 503 to work with the standard Bluetooth protocol stack 530. FIG. 6 shows a graphical illustration of a Bluetooth system 610 of the invention that comprises a software stack 600 and physical modules 604. Software stack 600 comprises application profiles 660, SDP 672, RFCOMM 674, L2CAP 640, HCI utility API 688, HCI 644, HCI-UART 676, HCI-USB 678, HCI-PCMCIA 680, UART WDM driver 682, USB WDM driver 684, PC card device driver 686, UART emulation 690 and software baseband modem lower driver 692. UART emulation 690 and software baseband modem lower driver are new features compared to a conventional Bluetooth host stack. Physical modules 604 comprise Bluetooth radio module 694, UART Bluetooth module 695, USB Bluetooth device 696 and PC card Bluetooth device 697.

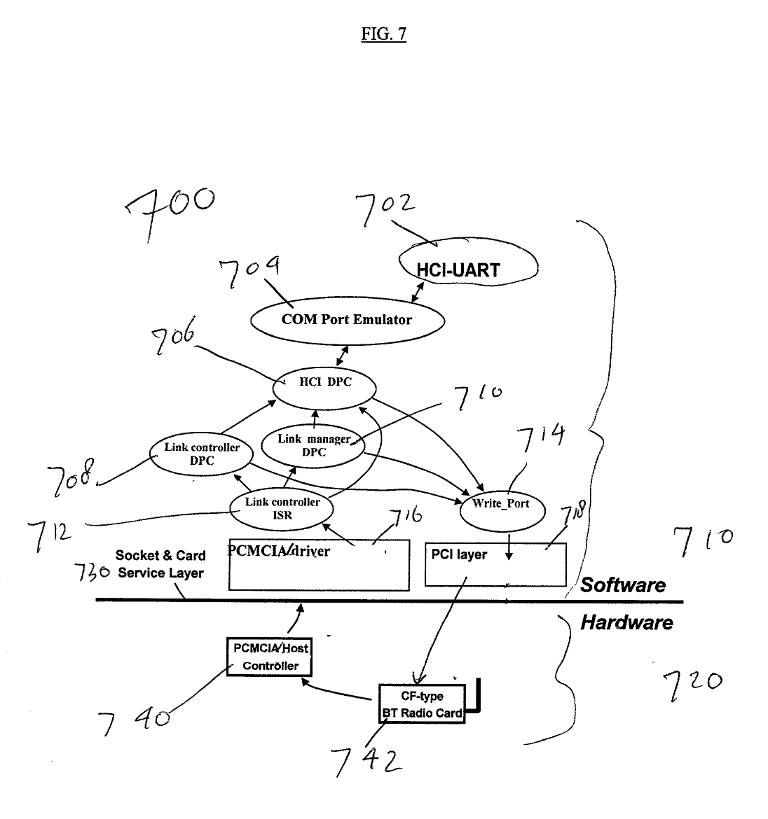

FIG. 7 shows a possible implementation of a Bluetooth system 700 that comprises software 710 and hardware 720 according to an embodiment of the invention. Hardware 720 and software 710 can communicate with each other using socket and card service layer 730. This example uses a PCMCIA as an example for the digital host interface. Hardware 720 comprises a CF-type Bluetooth radio card 742 that can be inserted in a PCMCIA host controller module 740. The CF-card 742 can generate an interrupt request (IREQ) to the PCMCIA controller 740. IREQ will then result in a PC system interrupt request (IRQ) to a PCMCIA driver 716. PCMCIA driver will typically call an ISR socket.c in response. Software 710 comprises HCI-UART 702, COM port emulator 704, HCI-DPC 706, link controller DPC 708, link manager DPC 710, link controller 712, write port 714, PCMCIA driver 716 and PCI layer 718. PCI layer 718 can address CF card 742 by using the PCMCIA address bus. Some of the functionalities of the software ISR, IST and processes are described hereafter.

Link controller ISR 712: performing Bluetooth baseband and link controller functions. ISR 712 is assigned with high processing priority for real-time requirement. ISR 712 can call DPC 708.

Link controller DPC (Deferred Procedure Call) 708: performing those functions in Bluetooth baseband and link controller with less real-time requirements.

Link manager DPC 710: performing Bluetooth LMP functions.

HCI DPC 706: for virtual HCI transport layer emulation, e.g., UART emulation.

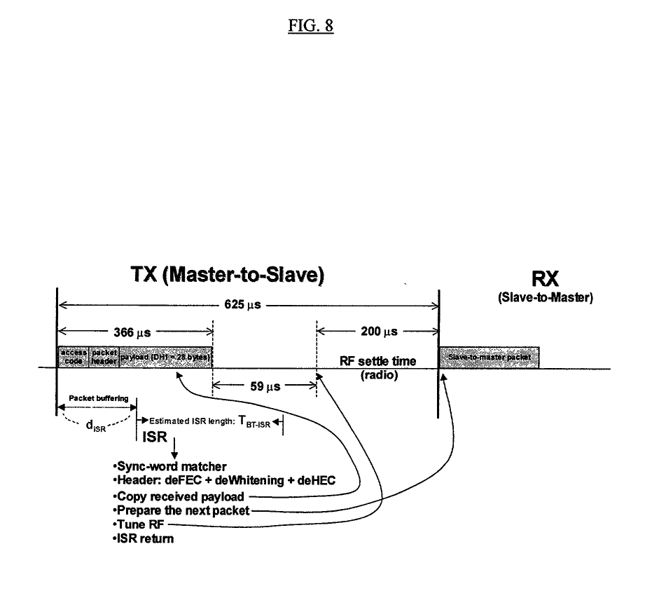

The link controller ISR 712 is performing all the real-time functions required for Bluetooth communications. In FIG. 8, an example of transmitting a DH1 packet is presented as a functional illustration of the link controller ISR 712. A radio module (e.g., CF-type Bluetooth radio card 742), upon receiving an access code from RF, will issue an interrupt request to a host (e.g., PCMCIA host controller 740). And after an interrupt latency period d_{ISR}, a link controller ISR (e.g., link controller ISR 712) will start to process the packet. Some important tasks for processing the packet include:

Sync-Word matching;

header checking: including de-whitening, de-HEC, de-FEC;

copying the payload to some other memory location for being processed by another DPC;

preparing to response a packet (if necessary);

frequency hopping sequence calculation and RF tuning; and

ISR returning.

After the link controller ISR, the processing of the payload will depend on the type of the packet. If it is a data packet, a link controller DPC (e.g., DPC 708) will be triggered. If it is a link manager packet, a link manager DPC (e.g., DPC 710) will be triggered. In the link controller DPC, the tasks left by link controller ISR will be processed. These tasks comprise.

payload header processing;

FEC decoding;

de-whitening;

decrypting (or encrypting for transmitting);

CRC decoding; and

sending the packet to HCI DPC.

In the link manager DPC, all the tasks regarding link manager will be processed.

From reading the present disclosure, other modifications will be apparent to persons skilled in the art. Such modifications may involve other features which are already known in the design, manufacture and use of devices for recording and retrieving real time communications and which may be used instead of or in addition to features already described herein. Although claims have been formulated in this application to particular combinations of features, it should be understood that the scope of the disclosure of the present application also includes any novel feature or novel combination of features disclosed herein either explicitly or implicitly or any generalization thereof, whether or not it mitigates any or all of the same technical problems as does the present invention. The applicants hereby give notice that new claims may be formulated to such features during the prosecution of the present application or any further application derived there from.

The word “comprising”,“comprise”, or “comprises” as used herein should not be viewed as excluding additional elements. The singular article “a” or “an” as used herein should not be viewed as excluding a plurality of elements.

What is claimed is:

1. A wireless connectivity system, for use with a mobile computing system's computer host for accessing remote information for use with an application program running on the host, the wireless connectivity system comprises:
a software modem module that is enabled to run on the host for performing wireless communication functionality and wherein the software modem module comprises:
an ISR (interrupt service routine) for a hard real-time baseband function;
an IST (interrupt service thread) for a secondary priority baseband function; and
a digital host interface, wherein the interface is enabled to communicate with a radio module.

2. The system of claim 1, wherein the software modem module comprises:
a MAC control process part for performing a data link layer function; and
a logical link control process part for interfacing to an upper network layer function.

3. The system of claim 1, wherein the radio module comprises:
an RF front end;
an analogue to digital converter;
a digital to analogue converter; and
a digital host interface controller that is enabled to communicate with the host.

4. The system of claim 1, wherein the wireless connectivity is based on wireless LAN.

5. The system of claim 1, wherein the wireless connectivity is based on Bluetooth.

6. The system of claim 1, wherein the ISR comprises a functionality for:
Bluetooth FEC, HEC and CRC;
access code generation; and
frequency hopping sequence calculation.

7. The system of claim 1, wherein the IST comprises a functionality for:
Bluetooth encryption;
Bluetooth authentication; and
Bluetooth random number generation.

8. The system of claim 1, wherein the software modem module comprises a link control process part for performing Bluetooth link controller and link manager functions.

9. The system of claim 8, wherein the software modem module further comprises a virtual HCI layer for emulating a standard Bluetooth HCI transport layer.

10. The system of claim 9, wherein the standard Bluetooth HCI transport layer is based on one of UART, USB, and PCMCIA.

11. The system of claim 1, wherein the wireless connectivity is based on Bluetooth and wherein the digital host interface is based on PCMCIA.

12. The system of claim 1, wherein the wireless connectivity is based on Bluetooth and wherein the digital host interface is based on CompactFlash.

13. The system of claim 1, wherein the wireless connectivity is based on Bluetooth and wherein the digital host interface is based on USB.

14. A method for achieving wireless connectivity, using a mobile computing system's computer host for accessing remote information for use with an application program running on the host, the method comprises the steps of:
running a software modem program on the host for performing wireless communication functionality; and
communicating over a digital host interface to a radio module, wherein the software modem program comprises:
a first module for performing an ISR (interrupt service routine) for a hard real-time baseband function; and
a second module for performing an IST (interrupt service thread) for a secondary priority baseband function.

15. The method of claim 14, wherein the software modem program further comprises:
a third module for performing a data link layer function by a MAC control process; and
a fourth module for interfacing to an upper network layer function by a logical link control process.

16. The method of claim 14, wherein the wireless connectivity is based on Bluetooth.

17. Software for achieving wireless connectivity, enabled to be running on a mobile computing system's computer host, for accessing remote information for use with an application program enabled to running on the host, the software comprises:
a first module that enables communication over a digital host interface to a radio module;
a second module for performing an ISR (interrupt service routine) for a hard real-time baseband function; and
a third module for performing an IST (interrupt service thread) for a secondary priority baseband function.

18. The software of claim 17, wherein the software further comprises:
a fourth module for performing a data link layer function by a MAC control process; and
a fifth module for interfacing to an upper network layer function by a logical link control process.

19. The software of claim 17, wherein the wireless connectivity is based on Bluetooth.
